(19) United States
(12) Patent Application Publication
(10) Pub. No.: US 2019/0043255 A1
(43) Pub. Date: Feb. 7, 2019

(54) POPULATION-BASED SURFACE MESH RECONSTRUCTION

(71) Applicant: 3M INNOVATIVE PROPERTIES COMPANY, St. Paul, MN (US)

(72) Inventors: Guruprasad Somasundaram, St. Paul, MN (US); Robert W. Shannon, Stillwater, MN (US); Evan J. Ribnick, St. Louis Park, MN (US); Ravishankar Sivalingam, San Jose, CA (US)

(21) Appl. No.: 16/075,072

(22) PCT Filed: Feb. 3, 2017
(86) PCT No.: PCT/US2017/016459

§ 371 Date: Aug. 2, 2018

Related U.S. Application Data
(60) Provisional application No. 62/293,884, filed on Feb. 11, 2016.

(51) Int. Cl. G06T 17/20

(52) U.S. Cl. CPC G06T 17/205; G06T 2210/41

(57) ABSTRACT

Reconstructed surface meshes can be generated based on a plurality of received surface meshes. Each surface mesh can include vertices and faces representing an object. The received surface meshes can be assigned to one of a plurality of groups, and a region of interest of each surface mesh within each group can be aligned. The reconstructed surface meshes can be generated based on the aligned regions of interest for each group.

### BACKGROUND

Dental and/or orthodontic fixtures, personal protective equipment (e.g., respirators, helmets, gloves, vests, visors, etc.), or other appliances are often designed for application to an object, such as a tooth, head, chest, hand, foot, or other object not limited to anatomy. In many cases, the size and/or shape of the appliance is designed as a “one-size-fits-all,” or is segregated based on assumed differences between object populations into various averaged categories, such as small, medium, and large sizes.

However, variations of object shapes within and between populations of the object can impact an accuracy of fit at an interface of the appliance and the object, thereby resulting in mechanical stress and/or pressure points at the interface. For instance, differences of tooth shapes within and between populations (e.g., widths) of teeth can result in mechanical stress at an application interface between a dental and/or orthodontic appliance and the tooth, thereby possibly decreasing the longevity of an adhesive bond between the appliance and the tooth. As another example, differences of facial features within and between populations can result in pressure points at an application interface of a respirator or other facial appliance, thereby possibly decreasing the ergonomic performance of the appliance.

### SUMMARY

In one example, a computer-implemented method includes receiving a plurality of surface meshes, each surface mesh including vertices and faces representing an object. The method further includes assigning, with a processor, each surface mesh of the plurality of surface meshes to one of a plurality of groups, and extracting a region of interest from each surface mesh of the plurality of surface meshes. The method further includes aligning with the processor, for each group of the plurality of groups, a region of interest of each surface mesh included in the group to generate a plurality of aligned surface meshes, and generating with the processor, for each group of the plurality of groups, a reconstructed mesh based on the vertices and faces of each aligned surface mesh included in the group.

In another example, a system includes at least one processor and computer-readable memory. The computer-readable memory is encoded with instructions that, when executed by the at least one processor, cause the system to receive a plurality of surface meshes, each surface mesh including vertices and faces representing an object. The computer-readable memory is further encoded with instructions that, when executed by the at least one processor, cause the system to assign each surface mesh of the plurality of surface meshes to one of a plurality of groups, and extract a region of interest from each surface mesh of the plurality of surface meshes. The computer-readable memory is further encoded with instructions that, when executed by the at least one processor, cause the system to align, for each group of the plurality of groups, a region of interest of each surface mesh included in the group to generate a plurality of aligned surface meshes, and generate, for each group of the plurality of groups, a reconstructed mesh based on the vertices and faces of each aligned surface mesh included in the group.

### BRIEF DESRIPTION OF THE DRAWINGS

FIG. 1 is a block diagram of an example system that can generate one or more reconstructed meshes based on a plurality of received surface meshes.

FIG. 2 is a graph of an example grouping of received surface meshes according to at least one measurable parameter.

FIGS. 3A-3C are perspective views of a surface mesh illustrating an example extraction of a region of interest from the surface mesh.

FIG. 4 is a side view of vertices of a point cloud of an example group of aligned regions of interest included in a group of surface meshes.

FIG. 5 is a perspective view of an example reconstructed mesh from a group of aligned surface meshes.

FIG. 6 is a perspective view of an example buccal tube appliance including an interface region based on a reconstructed mesh generated from a group of aligned surface meshes.

FIG. 7 is a flow diagram illustrating example operations to generate one or more reconstructed meshes based on a plurality of received surface meshes.

### DETAILED DESCRIPTION

According to techniques of this disclosure, brackets, buccal tubes, respirators, helmets, gloves, vests, visors, handles, or other appliances can be designed based on a reconstructed mesh that is generated from a plurality of received surface meshes. Each of the received surface meshes can include vertices and faces representing objects. Such objects can include, e.g., teeth, hands, feet, faces, heads, chests, eyes, or other objects (not limited to anatomy) to which an appliance can be designed and fitted for application. Each of the received surface meshes can be assigned to a population group based on a measurable parameter of the surface mesh that corresponds to a physical characteristic of the object. The measurable parameter may be selected based upon the object and/or appliance of interest. Example measurable parameters include, but are not limited to: width (e.g., tooth, head, finger, hand, etc.) length (e.g., tooth, head, finger, hand, etc.), distance (e.g., a cusp tip of a tooth to another, one cheek bone to another, etc.), surface area, initial registration error, final registration error, or other measurable parameters. A region of interest of each surface mesh can be extracted, and the surface meshes within each population group can be aligned. Regions of interest may be the surface mesh of an object in its entirety or may be a sample subset of the surface mesh. As an example, a surface mesh of an object may represent a molar. The region of interest may either be the entire molar or a portion of the molar. As another example, if a surface mesh represents an image of the facial features around the mouth, nose, and chin, then the region of interest may be just the mouth, chin, or nose, any combination thereof, any smaller sample thereof, or the complete image. Upon assembly of the reconstructed surface mesh, an initial registration error (i.e., difference between the original and reconstructed surface mesh) may be used as the measurable parameter to further improve accuracy and alignment of fit. The initial registration error may be defined as a comparison of the surfaces meshes to a reference mesh that is chosen randomly or based upon a measurable parameter. Aligned surface meshes within each group can be re-meshed (e.g., using Poisson surface reconstruction) to generate a reconstructed mesh that is representative of the object within each group. Other applicable reconstruction techniques include, but are not limited to: marching cubes, grid projection, surface element smoothing, greedy projection triangulation, convex hull, or concave hull. Appliances, such as a buccal tube configured to be applied to a cheek-facing surface (i.e., a buccal surface) of a molar, can be designed based on the reconstructed mesh for each population group, thereby increasing the accuracy of fit between the appliance and objects within each population group.

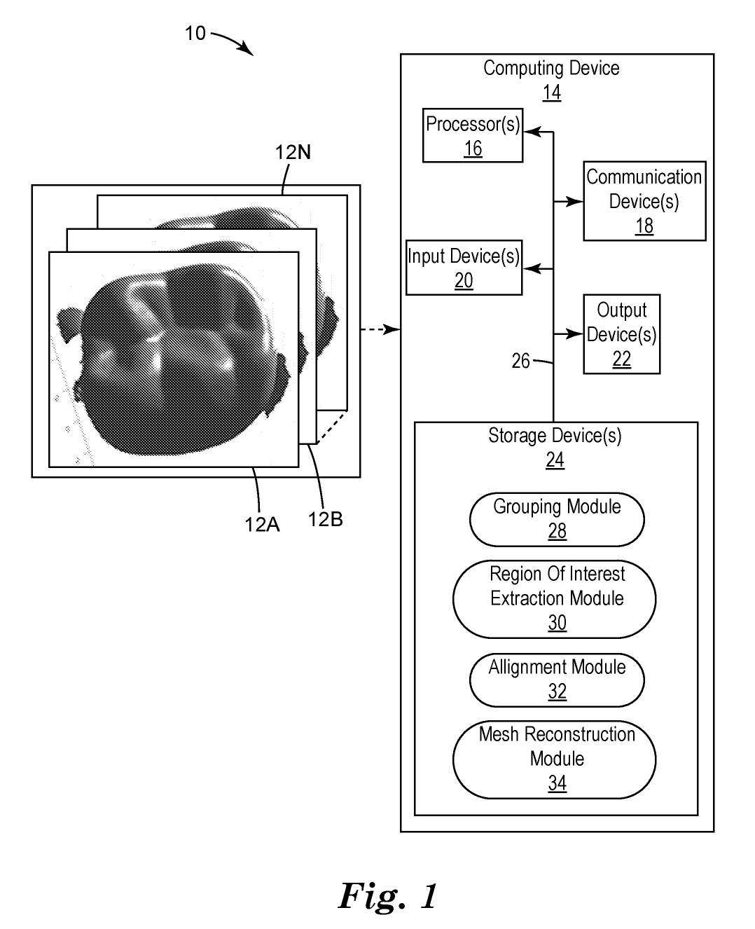

FIG. 1 is a block diagram of an example system 10 that can generate one or more reconstructed meshes based on a plurality of received surface meshes 12A-12N (collectively referred to herein as “surface meshes 12”). As illustrated in FIG. 1, system 10 includes computing device 14 that can receive surface meshes 12 via wired or wireless communication(s), or both. Computing device 14 includes one or more processors 16, one or more communication devices 18, one or more input devices 20, one or more output devices 22, and one or more storage devices 24. Each of components 16, 18, 20, 22, and 24 can be interconnected (physically, communicatively, and/or operatively) for inter-component communications, such as by one or more communication channels 26. For instance, communication channel(s) 26 can include a system bus, a network connection, an inter-process communication data structure, or any other method for communicating data. Storage devices 24, as illustrated in FIG. 1, can include grouping module 28, region of interest (ROI) extraction module 30, alignment module 32, and mesh reconstruction module 34.

As illustrated in the example of FIG. 1, surface meshes 12 can be three-dimensional (3D) meshes representative of teeth. The capture of surface meshes of an object is known in the art. An optical scanning system, such as the True Definition Scanner from 3M Company of St. Paul, Minn. may be used to provide a 3D geometric surface mesh. Surface meshes 12 can be representative of an entire span of teeth or individual teeth. However, while the examples described herein are described with respect to 3D meshes of teeth, aspects of this disclosure are not so limited. For instance, surface meshes 12 can be two-dimensional (2D) or 3D meshes representative of any object for which an appliance can be designed for application thereto, such as facial features, heads, chests, arms, hands, feet, or other objects not limited to anatomy. Surface meshes 12, in the example of FIG. 1, are polygonal meshes (e.g., triangular meshes) that each includes vertices, edges, and faces representing the teeth associated with the respective one of surface meshes 12. Vertices of each of surface meshes 12 can be 2D or 3D coordinates within a coordinate system (e.g., a Euclidean coordinate system) representing points on the surface of the teeth. The collection of vertices of each of surface meshes 12 can be considered a point cloud that represents the collection of unconnected vertices. Edges of each of surface meshes 12 are encoded connections between vertices, closed sets of which are considered faces of the respective one of surface meshes 12. Faces of each of surface meshes 12 (and/or the vertices associated with each face) can be associated with (e.g., encoded with) a surface normal that is orthogonal to a plane defined by the polygonal face. As one example, any one or more of surface meshes 12 can be a triangular mesh, such that each face of the surface mesh is defined by a closed set of three edges between three vertices, resulting in a surface that can be represented as a set of small triangular planar patches.

Surface meshes 12 can be obtained and/or determined from optical scans (e.g., intra-oral scans), scans of impressions of teeth (e.g., laser scans), or both. In general, surface meshes 12 can be obtained and/or determined from any data source capable of generating 2D or 3D representations of the object (e.g., teeth) associated with surface meshes 12. Each of surface meshes 12 can be obtained from a different patient, thereby resulting in a population of data corresponding to scans of multiple (e.g., tens, hundreds, thousands, or more) different patients. Similarly, in examples where surface meshes 12 are representative of other objects, such as facial features, hands, feet, or other objects, surface meshes 12 can be obtained from multiple individuals, thereby resulting in a population of data that corresponds to the aggregate of the multiple individuals.

As illustrated in FIG. 1, computing device 14 can receive surface meshes 12 via one or more wired or wireless communications, or both. In certain examples, computing device 14 can receive 2D and/or 3D models of objects corresponding to each of surface meshes 12, and can determine each of surface meshes 12 from the received models. While illustrated in FIG. 1 as including three surface meshes 12 (i.e., surface mesh 12A, surface mesh 12B, and surface mesh 12N), it should be understood that surface meshes 12 can include any number of surface meshes, such that the letter “N” of surface mesh 12N represents any arbitrary number of surface meshes 12.

Examples of computing device 14 can include, but are not limited to, servers (i.e., Cloud), mainframes, desktop computers, laptop computers, tablet computers, mobile phones (including smartphones), personal digital assistants (PDAs), or other computing devices. One or more processors 16, in one example, are configured to implement functionality and/or process instructions for execution within computing device 14. For instance, processor(s) 16 can be capable of processing instructions stored in storage device(s) 24, such as instructions to generate one or more reconstructed meshes from surface meshes 12, as is further described below. Examples of processor(s) 16 can include any one or more of a microprocessor, a controller, a digital signal processor (DSP), an application specific integrated circuit (ASIC), a field-programmable gate array (FPGA), or other equivalent discrete or integrated logic circuitry.

One or more storage devices 24 can be configured to store information within computing device 14 during operation. Storage device(s) 24, in some examples, are described as a computer-readable storage medium. In some examples, a computer-readable storage medium can include a non-transitory medium. The term “non-transitory” can indicate that the storage medium is not embodied in a carrier wave or a propagated signal. In certain examples, a non-transitory storage medium can store data that can, over time, change (e.g., in RAM or cache). In some examples, storage device(s) 24 are a temporary memory, meaning that a primary purpose of storage device(s) 24 is not long-term storage. Storage device(s) 24, in some examples, are described as a volatile memory, meaning that storage device(s) 24 do not maintain stored contents when power to computing device 14 is turned off. Examples of volatile memories can include random access memories (RAM), dynamic random access memories (DRAM), static random access memories (SRAM), and other forms of volatile memories. In some examples, storage device(s) 24 are used to store program instructions for execution by processor(s) 16. Storage device(s) 24, in one example, are used by software or applications miming on computing device 16 (e.g., any one or more of grouping module 28, ROI extraction module 30, alignment module 32, and mesh reconstruction module 34) to temporarily store information during program execution.

Storage device(s) 24, in one example, utilize communication device(s) 18 to communicate with external devices via one or more networks, such as one or more wired or wireless communication networks, or both. Communication device(s) 18 can include a network interface card, such as an Ethernet card, an optical transceiver, a radio frequency transceiver, or any other type of device that can send and receive data. Other examples of such network interfaces can include Bluetooth, 3G, 4G, and WiFi radio computing devices, as well as Universal Serial Bus (USB).

Computing device 14, as illustrated in FIG. 1, can include one or more input devices 20. Input device(s) 20, in some examples, are configured to receive input from a user. Examples of input device(s) 20 can include a mouse, a keyboard, a microphone, a camera device, a presence-sensitive and/or touch-sensitive display, or other type of device configured to receive input from a user.

One or more output devices 22 can be configured to provide output to a user. Examples of output device(s) 22 can include a display device, a sound card, a video graphics card, a speaker, a cathode ray tube (CRT) monitor, a liquid crystal display (LCD), touch-sensitive and/or presence-sensitive display, or other type of device for outputting information in a form understandable to users or machines.

As illustrated in FIG. 1, storage device(s) 24 can include grouping module 28, ROI extraction module 30, alignment module 32, and mesh reconstruction module 34. Each of modules 28, 30, 32, and 34 can include computer-readable instructions that, when executed by processor(s) 16, cause computing device 14 to operate in accordance with techniques described herein. While illustrated and described as separate modules, any one or more of grouping module 28, ROI extraction module 30, alignment module 32, and mesh reconstruction module 34 can be implemented as a same or different module. Similarly, while examples of this disclosure are described with respect to a single computing device 14, in other examples, system 10 can include two or more computing devices 14, with functionality attributed herein to computing device 14 distributed among the two or more computing devices 14.

In operation, computing device 14 receives surface meshes 12 via, e.g., communication device(s) 18. Grouping module 28 assigns each of surface meshes 12 to one of a plurality of groups based on, e.g., at least one measurable parameter of the respective one of surface meshes 12. Processor 16 analyzes the surface mesh to identify the at least one measurable parameter of interest and assigns the surface mesh to a group based upon statistical proximity (e.g., within 5% of the width, length, or distance) or frequency of occurrence. For instance, as is further described below, grouping module 28 can assign each of surface meshes 12 to one of a plurality of groups based on the measurable parameter of tooth width. In other examples, such as when surface meshes 12 represent objects other than teeth, the measurable parameter can correspond to one or more physical characteristics of the object represented by surface meshes 12 that are measurable via the surface meshes, such as a distance between cheek bones (e.g., for use when designing a respirator appliance), head width (e.g., for use when designing a helmet and/or visor appliance), hand width (e.g., for use when designing an appliance that covers the hands, such as gloves), or other physical characteristics.

In certain examples, grouping module 28 can assign each of surface meshes 12 to one of a plurality of groups based on multiple measurable parameters. For instance, each of surface meshes 12 can be associated with multiple measurable parameters, such as width, length, distance, angle, or other measurable parameters. Such multiple measurable parameters can be represented as, e.g., a vector, array, matrix, sequence, or other representation from which grouping module 28 can determine differences between measurable parameters of corresponding surface meshes. Examples of such differences can include, but are not limited to: a Mahalanobis distance, an indication of an angle between vectors (e.g., an angle, a cosine of an angle, a sine of an angle, or other indications of an angle), or an indication of correlation between vectors.

ROI extraction module 30 can extract a region of interest from each of surface meshes 12. For example, ROI extraction module 30 can extract a buccal surface (i.e., a cheek-facing surface) of molars represented by surface meshes 12. Alignment module 32 can align, for each of the plurality of groups, the region of interest of each surface mesh included in the group to generate a plurality of aligned surface meshes. Mesh reconstruction module 34 can generate, for each of the plurality of groups, a reconstructed mesh based on the vertices and faces of each aligned surface mesh included in the group. Accordingly, system 10, implementing techniques of this disclosure, can generate a reconstructed mesh for each of a plurality of population groups. Vertices and faces of each reconstructed mesh can be representative of an aggregate of objects of each of the surface meshes included in the group. An appliance, such as a buccal tube configured to be applied to a buccal surface of a molar, can be designed for each group based on the reconstructed surface mesh associated with the group. For example, an interface region of the appliance (e.g., a region of a buccal tube configured to be applied to the buccal surface of a molar, a region of a respirator configured to be placed adjacent to the face, or other interface regions) can be designed to complement (e.g., match) the corresponding interface region of the reconstructed mesh. As such, techniques described herein can increase an accuracy of fit between the appliance for each group and objects (e.g., teeth) having a measurable parameter (e.g., tooth width) corresponding to the group.

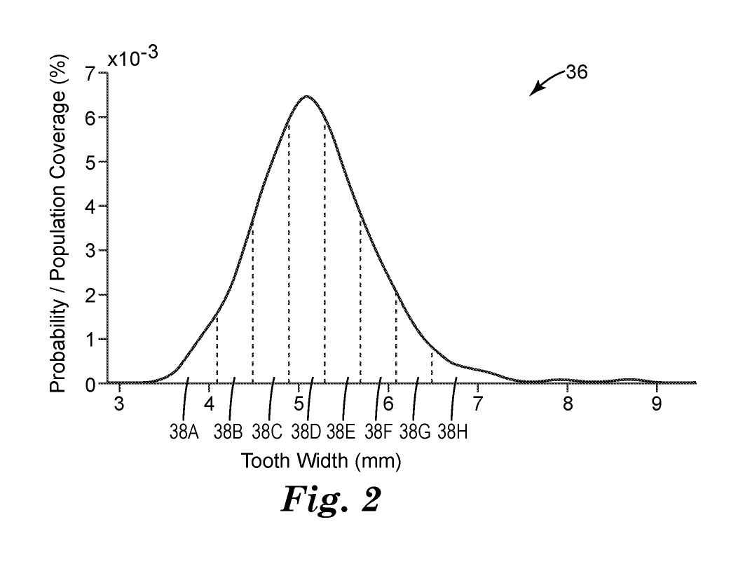

FIG. 2 is a graph 36 of an example grouping of surface meshes 12 (of FIG. 1) according to a measurable parameter corresponding to tooth width. In the example of FIG. 2, graph 36 illustrates an example grouping of surface meshes 12, each corresponding to a lower right 2^{nd} molar, though it should be understood that the example techniques described herein can be applied to groupings of different teeth and different objects, such as faces, heads, hands, feet, chests, or other objects not limited to anatomy. In some examples, each of surface meshes 12 can be representative of a single tooth, such as the lower right 2^{nd} molar described with respect to FIG. 2. In other examples, each of surface meshes 12 can be representative of more than one tooth, and computing device 14 (of FIG. 1) can segregate portions of each of surface meshes 12 to extract the portion corresponding to a single tooth.

As illustrated in FIG. 2, grouping module 28 (of FIG. 1) can assign each of surface meshes 12 to one of the plurality of groups 38A-38H (collectively referred to herein as “groups 38”). In the example of FIG. 2, each of groups 38 corresponds to the physical characteristic of tooth width of the lower right 2^{nd} molar and includes a range of measurable parameters corresponding to the tooth width, each range extending from a lower bound of the tooth width to an upper bound of the tooth width for the respective group. As illustrated, ranges of the measurable parameter corresponding to tooth width can be mutually exclusive between groups 38, such that no two of groups 38 includes a same value of the measurable parameter.

In some examples, grouping module 28 can determine a tooth width for each of surface meshes 12 as a distance between a mesial-lingual cusp tip and a distal-buccal cusp tip of the molar associated with each of surface meshes 12. In other examples, grouping module 28 can determine the tooth width for each of surface meshes 12 using other measurable parameters indicative of tooth width, such as a distance from a mesial-lingual cusp tip to a central-buccal cusp tip (e.g., for lower left and right 1^{st} molars that have three buccal cusps), a longest distance between outer-most edges of the tooth, or other measurable parameters indicative of tooth width. Landmark points used to determine each tooth width, such as cusp tips, outer-most edges, or other landmark points, can be manually annotated (e.g., manually encoded with each of surface meshes 12 by a user) and/or can be automatically determined by computing device 14, such as via optical recognition techniques, peak detection algorithms, edge detection algorithms, or other techniques to determine cusp tips, outer-most edges, or other landmarks points usable to determine the measurable parameter indicative of tooth width.

In the example of FIG. 2, groups 38 include eight groups (i.e., groups 38A, 38B, 38C, 38D, 38E, 38F, 38G, and 38H). In other examples, groups 38 can include greater or fewer than eight separate groups 38, including examples having only a single group. The total number of groups 38 can be determined (e.g., manually and/or by grouping module 28) based on one or more constraints, such as a maximum number of groups 38, a minimum number of groups 38, a maximum number of surface meshes 12 included in any one of groups 38, a minimum number of surface meshes 12 included in any one of groups 38, or other constraints. In certain examples, grouping module 28 can determine the number and/or ranges of measurable parameters for each of groups 38 using, e.g., a clustering algorithm that identifies the number of groups 38 and/or ranges of measurable parameters for each of groups 38 based on differences of the measurable parameter between surface meshes 12. For instance, grouping module 28 can utilize a clustering algorithm that groups those surface meshes 12 having a measurable parameter that satisfy threshold grouping criteria, such as a threshold maximum difference between the measurable parameters.

Clustering module 28, in certain examples, can determine a key statistic of the measurable parameters among groups 38, such as by using a histogram of the number of surface meshes 12 included in each of groups 38, a maximum of a probability distribution function of the measurable parameters among groups 38 (e.g., using kernel density smoothing), or other techniques. Examples of key statistics can include, but are not limited to: a mode, a mean, a median, or intermediate values thereof. Grouping module 28, in certain examples, can center the range of measurable parameters for one of groups 38 about the key statistic of the measurable parameters among groups 38. For instance, as illustrated in FIG. 2, grouping module 28 can center the range of the measurable parameter corresponding to tooth width of group 38D about a determined mode (e.g., 5.09 millimeters in this example) of the measurable parameters among groups 38. In certain examples, additional groups 38 can be determined symmetrically about an identified one of groups 38 corresponding to the key statistic (e.g., group 38D corresponding to a key statistic of a mode in this example) until the aggregate of groups 38 includes at least 95 percent of the measurable parameters among surface meshes 12. Ranges of those of groups 38 that include measurable parameters in the greatest and least percentiles of the measurable parameter can be extended such that each of surface meshes 12 is included in at least one of groups 38.

Accordingly, computing device 14 can assign each of surface meshes 12 to one of a plurality of groups according to at least one measurable parameter of the respective one of surface meshes 12. While the example of FIG. 2 has been described with respect to a measurable parameter corresponding to the width of teeth, the techniques described herein can be applied to different measurable parameters (including multiple measurable parameters associated with each surface mesh) corresponding to physical characteristics of different objects, such as facial features (e.g., a measurable parameter corresponding to a distance between cheek bones, a length of a nose, or any one or more other measurable parameters corresponding to physical characteristics of facial features), heads (e.g., head width, head circumference, or any one or more other measurable parameters corresponding to physical characteristics of a head), hands (e.g., hand width, finger length, or any one or more other measurable parameters corresponding to physical characteristics of a hand), or any one or more other measurable parameters corresponding to physical characteristics of objects not limited to anatomy.

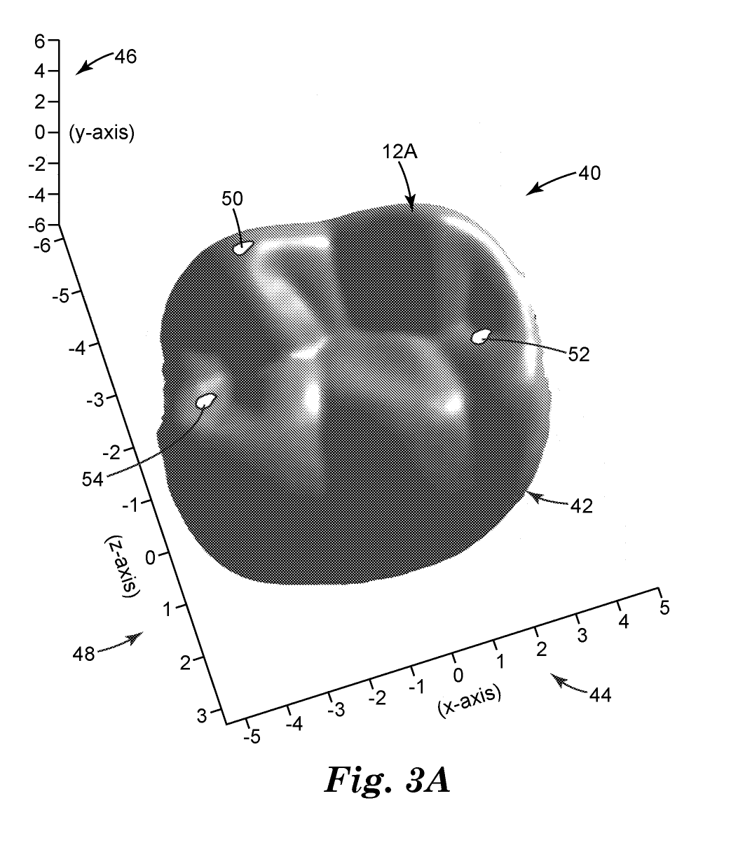

FIGS. 3A-3C are perspective views illustrating an example extraction of a region of interest corresponding to a buccal surface of a molar from surface mesh 12A. FIG. 3A illustrates surface mesh 12A aligned with coordinate system 40. FIG. 3B illustrates surface mesh 12A aligned with coordinate system 40 and showing plane 41 segregating region of interest 42 corresponding to the buccal surface of the molar from a remainder of surface mesh 12A. FIG. 3C illustrates region of interest 42 corresponding to the buccal surface after extraction from surface mesh 12A.

As illustrated in FIG. 3A, surface mesh 12A can be aligned with coordinate system 40 by, e.g., ROI extraction module 30 (FIG. 1). Coordinate system 40 can include first axis 44 (labeled “x-axis”), second axis 46 (labeled “y-axis”), and third axis 48 (labeled “z-axis”). As in the illustrated example, each of first axis 44, second axis 46, and third axis 48 can be mutually orthogonal (e.g., a Euclidean coordinate system). ROI extraction module 30 can determine an origin of coordinate system 40 as a midpoint between mesial-lingual cusp tip 50 and distal-buccal cusp tip 52. ROI extraction module 30 can determine a positive direction of first axis 44 to align with a unit vector extending from the determined origin in a direction toward distal-buccal cusp tip 52 (for surface meshes corresponding to teeth in the upper left or lower left quadrants of the mouth) or in a direction from the determined origin in a direction toward mesial-buccal cusp 54 (for surface meshes corresponding to teeth in the upper right or lower right quadrants of the mouth). ROI extraction module 30 can determine second axis 46 to align with a unit vector extending from the determined origin along a root line of the tooth, a positive direction extending from the origin toward an occlusal surface of the tooth. ROI extraction module 30 can determine third axis 48 to be mutually orthogonal to each of first axis 44 and second axis 46 such that coordinate system 40 is a right-handed coordinate system and a positive direction of third axis 48 aligns with a unit vector extending from the determined origin in a direction toward a buccal surface of the tooth. As such, positive values of third axis 48 correspond to the buccal surface of the molar corresponding to surface mesh 12A.

As illustrated in FIG. 3B, ROI extraction module 30 can identify region of interest 42 corresponding to the buccal surface of the tooth by segregating values of surface mesh 12A having positive values along third axis 48. Such values are illustrated in FIG. 3B using a zero-valued plane 41 extending in third axis 48. In other examples, ROI extraction module 30 need not align surface mesh 12A with and/or identify region of interest 42 based on coordinate system 40. For instance, ROI extraction module 30 can identify, in certain examples, region of interest 42 by aligning surface mesh 12A with a baseline (or template) surface mesh, and can identify region of interest 42 based on a location of a corresponding region of interest within the template surface mesh. ROI extraction module 30 can align surface mesh 12A with the template surface mesh by aligning, e.g., landmark or other identified locations of the template surface mesh with corresponding locations of surface mesh 12A. Landmark locations can correspond to, for example, physical features of an object represented by the template surface, such as landmark facial features (e.g., locations of cheekbones, mouth, eyes, or other facial features), landmark tooth locations (e.g., cusp tips, grooves, or other landmark tooth locations), or other physical features of objects not limited to anatomy. As one example, ROI extraction module 30 can align the landmark locations of surface mesh 12A and the template surface mesh using an iterative closest point (ICP) or other alignment algorithm. ROI extraction module 30 can identify and/or extract a region of interest (e.g., region of interest 42) from surface mesh 12A based on the location of the region of interest within the template surface mesh, such as by identifying portions of surface mesh 12A associated with corresponding locations of the region of interest within the template surface mesh.

FIG. 3C illustrates region of interest 42 after extraction (e.g., by ROI extraction module 30) from surface mesh 12A. While the examples of FIGS. 3A-3C have been illustrated and described with respect to extraction of a region of interest corresponding to a buccal surface of a molar, the example techniques can be applied to extraction of different regions of interest corresponding to teeth and/or other objects. For instance, a lingual or palatal (i.e., tongue-facing or palate-facing) region of interest of the tooth can be extracted in the examples of FIGS. 3A-3C as the region of surface mesh 12A corresponding to negative values of third axis 48. In addition, the example techniques can be applied to different objects, such as to extract a facial region of interest from a surface mesh corresponding to a human head. For instance, in the example of a surface mesh corresponding to a human head, an origin of coordinate system 40 can be determined as a midpoint between the two ears of the head, a positive direction of first axis 44 can be determined to extend in a direction along a unit vector from the origin to a right ear of the head, and a positive direction of second axis 46 can be determined to extend in a direction along a unit vector from the origin down the neck line of the head. In such an example, a region of interest corresponding to facial features of the head can be extracted as those values of the surface mesh having positive values along third axis 48.

Accordingly, ROI extraction module 30 can identify a region of interest of any one or more of surface meshes 12 and can extract the region of interest from the remainder of the respective one of surface meshes 12. Extraction of the region of interest can increase accuracy of alignment operations of surface meshes 12 by decreasing a total number of vertices that are required to be aligned.

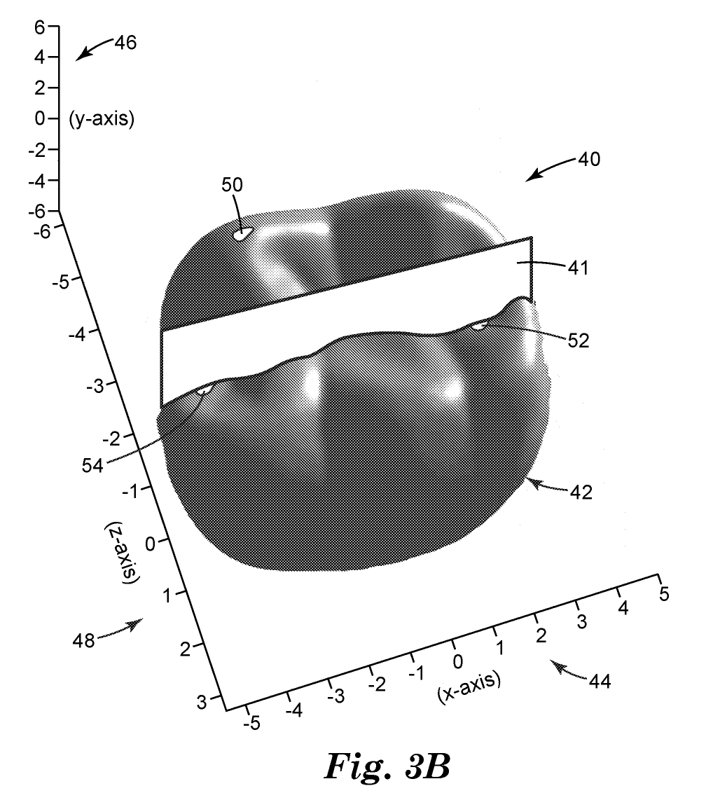

FIG. 4 is a side view of vertices of point cloud 56 of aligned regions of interest of surface meshes 12 (FIG. 1) included in group 38D (FIG. 2). While the example of FIG. 4 is described with respect to group 38D for purposes of clarity and ease of discussion, it should be understood that the example techniques are applicable to any and all of groups 38 to align vertices of those of surface meshes 12 included in the respective group.

Alignment module 32 (FIG. 1) can align regions of interest of those of surface meshes 12 included in group 38D. For instance, in certain examples, alignment module 32 can align regions of interest of surface meshes 12 included in group 38D to a common coordinate system. In some examples, alignment module 32 can align regions of interest of surface meshes 12 included in group 38D by aligning landmark or other pre-defined points of surface meshes 12. The aggregate of vertices of the aligned surface meshes 12 included in group 38D form the vertices of point cloud 56. As an example, a common coordinate system can be a coordinate system associated with any of surface meshes 12 included in group 38D. For instance, the common coordinate system can be a coordinate system associated with the one of surface meshes 12 included in group 38D having a median measurable parameter (e.g., tooth width) among the surface meshes 12 included in group 38D.

Alignment module 32 can align the regions of interest of each of surface meshes 12 included in group 38D (e.g., to the common coordinate system) using an iterative closest point (ICP) algorithm or other alignment algorithm that minimizes differences between a reference point cloud (i.e., the point cloud of vertices associated with the one of surface meshes 12 determined as common coordinate system) and a target point cloud (e.g., each of the remaining ones of surface meshes 12 included in group 38D) via determined rotational matrices that transform coordinates of the target point clouds to minimize distances between vertices between the reference point cloud and the target point clouds. Alignment of the regions of interest of surface meshes 12 included in group 38D (as opposed to the entirety of the surface meshes 12 included in group 38D) can increase the accuracy of alignment as well as decrease the operational cost associated with alignment by decreasing the total number of vertices to be aligned.

In some examples, alignment module 32 can first align a first axis (e.g., an x-axis) of each of the regions of interest of surface meshes 12 included in group 38D, and can subsequently align the remaining two axes (e.g., both an x-axis and a y-axis) of each of the regions of interest of surface meshes 12 included in group 38D using the iterative closest point algorithm or other alignment algorithm. In such examples, alignment module 32 can further decrease an operational cost of the alignment by decreasing the number of operations performed by the iterative closest point or other alignment algorithm (which can be operationally costly). Accordingly, alignment module 32 can align each of the regions of interest of surface meshes 12 included in group 38D to determine the aggregate point cloud 56 including vertices of each of the aligned regions of interest.

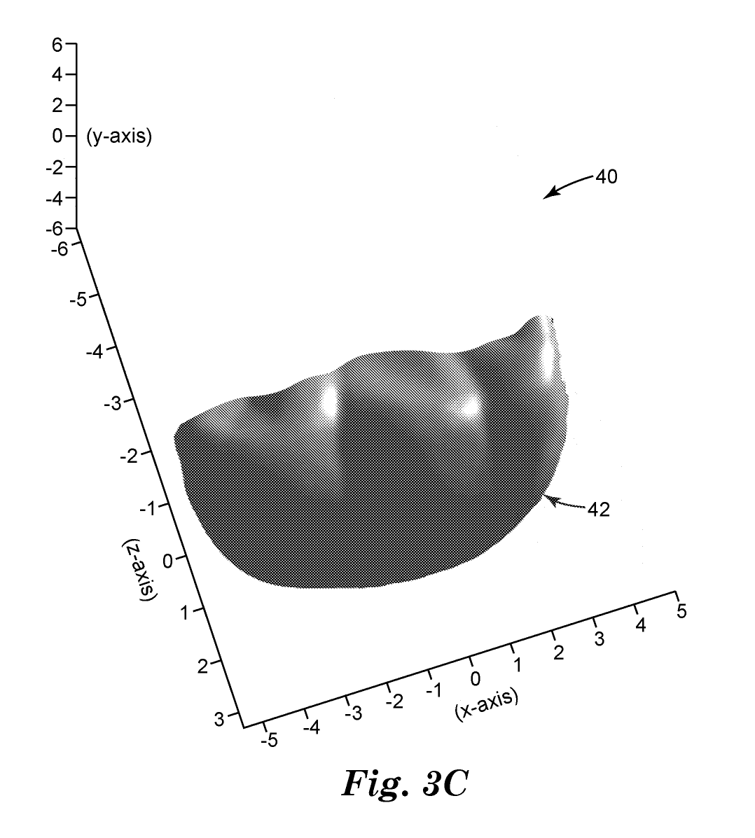

FIG. 5 is a perspective view of an example reconstructed mesh 58 generated from a group of aligned surface meshes. In the example of FIG. 5, reconstructed mesh 58 is generated from point cloud 56 (FIG. 4) of the aligned regions of interest of surface meshes 12 (FIG. 1) included in group 38D (FIG. 2). While the example of FIG. 5 is described with respect to point cloud 56 associated with group 38D for purposes of clarity and ease of discussion, it should be understood that the example techniques are applicable to any aligned group of surface meshes 12 of any or all of groups 38 to generate a reconstructed surface mesh from the aligned surface meshes included in the respective group.

Mesh reconstruction module 34 (FIG. 1) can generate reconstructed mesh 58 based on vertices and faces of each of the aligned surface meshes included in group 38D. For instance, mesh reconstruction module 34 can generate reconstructed mesh 58 using a Poisson surface reconstruction algorithm or other surface reconstruction algorithm that generates a reconstructed mesh representative of two or more input meshes. In some examples, mesh reconstruction module 34 can generate reconstructed mesh 58 using only the vertices of aligned surface meshes 12 included in group 38D and normal vectors associated with faces of each of the aligned surface meshes 12 included in group 38D. That is, each vertex of the vertices of point cloud 56 can be associated with a normal vector that is orthogonal to a face of the respective one of surface meshes 12 from which the vertex is derived. Rather than re-estimate surface normals for each of the faces of reconstructed mesh 58, mesh reconstruction module 34 can generate reconstructed mesh 58 using surface normals associated with vertices of point cloud 56, thereby decreasing computation time associated with the surface reconstruction and resulting in a cleaner (e.g., smoother and more accurate) reconstructed mesh 58.

In some examples, mesh reconstruction module 34 can apply a radius outlier filter to vertices of point cloud 56 prior to determining reconstructed mesh 58 to exclude spurious vertices from the mesh reconstruction operations, thereby increasing smoothness and accuracy of reconstructed mesh 58. For example, mesh reconstruction module 34 can exclude those vertices having less than a threshold number of neighboring vertices within a threshold distance. The threshold number of neighboring vertices and threshold distance can be based on a density of vertices defined by, e.g., a mesh resolution. For instance, as the mesh resolution increases, any one or more of the threshold number of neighboring vertices and the threshold distance can decrease. As the mesh resolution decreases, the threshold number of neighboring vertices and/or the threshold distance can increase. As one example, the threshold number of neighboring vertices can be fifty vertices, and the threshold distance can be 0.5 millimeters.

In certain examples, mesh reconstruction module 34 can apply a radius outlier filter to vertices of reconstructed mesh 58 subsequent to generating reconstructed mesh 58 to exclude spurious regions of reconstructed mesh 58, thereby increasing smoothness and accuracy of reconstructed mesh 58. For example, mesh reconstruction module 34 can exclude vertices from reconstructed mesh 58 having less than a threshold number of vertices from point cloud 56 (i.e., the point cloud from which reconstructed mesh 58 is generated) within a threshold distance. As described above, each of the threshold number of vertices and the threshold distance can be based on the mesh resolution, such as a threshold number of vertices of one hundred vertices from point cloud 56 within a threshold distance of 0.5 millimeters.

In some examples, mesh reconstruction module 34 can apply smoothing operations to reconstructed mesh 58 subsequent to generating reconstructed mesh 58, thereby increasing smoothness and accuracy of reconstructed mesh 58. For example, mesh reconstruction module 34 can apply Laplacian smoothing operations to reconstructed mesh 58 by replacing each vertex of reconstructed mesh 58 with a weighted average of the coordinates of neighboring vertices that are directly connected to the respective vertex by an edge. The weights can be, e.g., inversely proportional to a length of the connecting edges.

Accordingly, mesh reconstruction module 34 can generate reconstructed mesh 58 based on vertices and faces of each of the surface meshes 12 included in group 38D. Vertices and faces of reconstructed mesh 58 can be representative of an aggregate of objects corresponding to each of the surface meshes 12 included in group 38D. As such, reconstructed mesh 58 can be utilized to design an appliance, such as a buccal tube, having an interface that is contoured to match (e.g., within design tolerances) reconstructed mesh 58, thereby increasing an accuracy of fit between the appliance and objects having a measurable parameter that is included in the range of measurable parameters of group 38D. Similarly, mesh reconstruction module 34 can generate reconstructed meshes for any one or more of groups 38, thereby enabling an appliance to be designed for any one or more (e.g., each) of population groups 38.

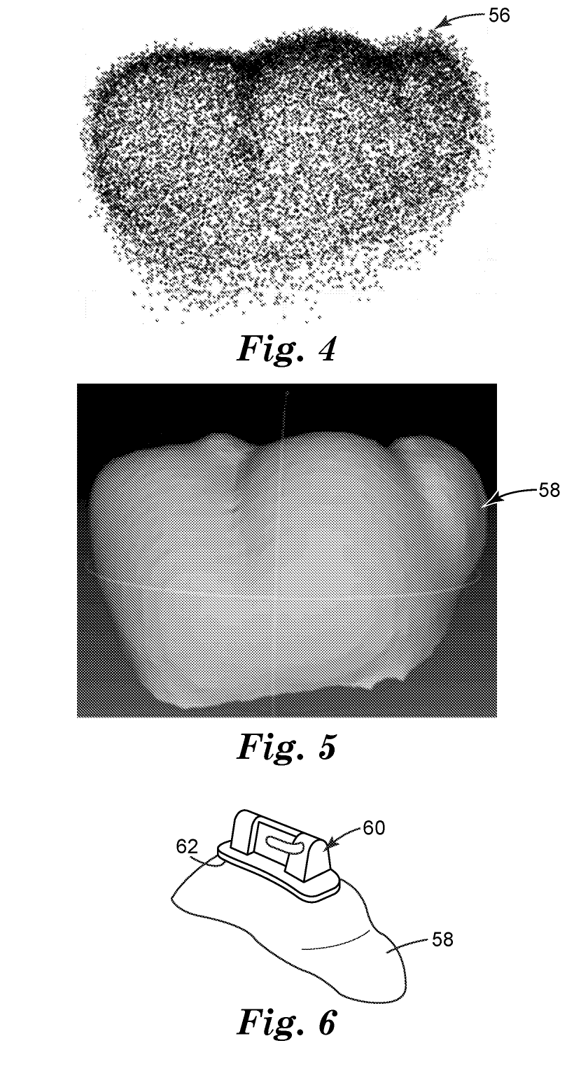

FIG. 6 is a perspective view of buccal tube appliance 60 including interface region 62 designed based on reconstructed surface mesh 58. In the example of FIG. 6, buccal tube appliance 60 is shown in an applied orientation with respect to a portion of reconstructed mesh 58. While the example of FIG. 6 is described for purposes of clarity and ease of discussion with respect to a buccal tube appliance designed based on reconstructed mesh 58, it should be understood that the example techniques are applicable to any appliance that can be designed to interface with any object, such as a respirator designed to interface with a human face, a helmet designed to interface with a human head, glasses designed to interface with a human face, or other appliances designed to interface with any object not limited to anatomy.

As illustrated in FIG. 6, buccal tube appliance 60 includes interface region 62 that is configured to interface with (e.g., physically touch) an object represented by reconstructed mesh 58. Interface region 62 can be designed to match (e.g., within design and/or manufacturing tolerances) a region of reconstructed mesh 58 with which interface region 62 is configured to interface. Accordingly, interface region 62 of buccal tube appliance 60 can be designed to minimize mechanical stress after application, thereby helping to increase the longevity of an adhesive bond between interface region 62 and a tooth to which it is applied.

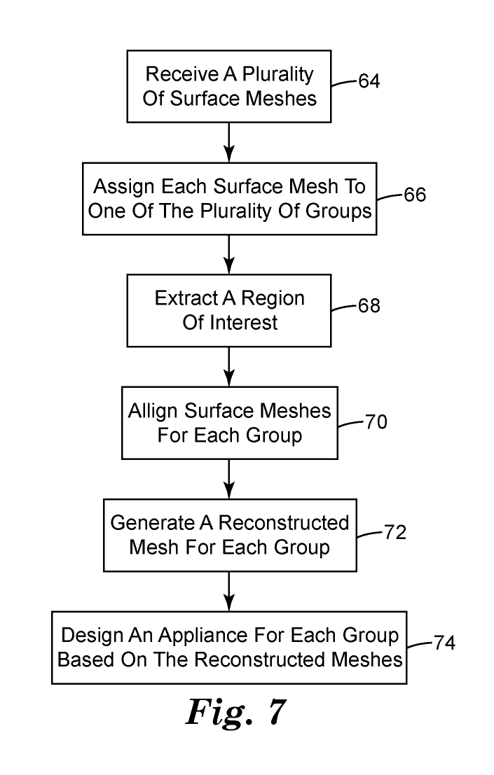

FIG. 7 is a flow diagram illustrating example operations to generate one or more reconstructed meshes based on a plurality of received surface meshes. For purposes of clarity and ease of discussion, the example operations are described below within the context of system 10 of FIG. 1 and the examples of FIGS. 2-6.

A plurality of surface meshes can be received (Step 64). Each surface mesh can include vertices and faces representing an object. For instance, computing device 14 can receive surface meshes 12 via communication device(s) 18, each of surface meshes 12 including vertices and faces representing one or more teeth. In some examples, each of the plurality of surface meshes can be a three-dimensional surface mesh. For example, each of surface meshes 12 can be associated with a three-dimensional Euclidean coordinate system.

Each surface mesh of the plurality of surface meshes can be assigned with the computing device 14 represented in FIG. 1 to one of a plurality of groups (Step 66). For example, grouping module 28 can assign each of surface meshes 12 to one of groups 38. Assigning each surface mesh to one of the plurality of groups can be performed based on a measurable parameter of the surface mesh. For instance, grouping module 28 can assign each of surface meshes 12 to one of groups 38 based on a measurable parameter of the surface mesh that corresponds to tooth width, such as a distance between a vertex of the surface mesh corresponding to a mesial-lingual cusp tip and a vertex of the surface mesh corresponding to a distal-buccal cusp tip. The measurable parameter can correspond to a physical characteristic of an object represented by the surface mesh, such as a measurable parameter corresponding to tooth width of a tooth represented by the surface mesh. The plurality of groups can be determined based on a distribution of the measurable parameter among the plurality of surface meshes. Determining the plurality of groups based on the distribution of the measurable parameter among the plurality of surface meshes can be performed using a clustering algorithm that identifies the plurality of groups based on differences of the measurable parameter between surface meshes. For example, grouping module 28 can determine groups 38 using a clustering algorithm that identifies the number of groups 38 and/or ranges of measurable parameters for each of groups 38 based on differences of the measurable parameter between surface meshes 12. Each of the plurality of groups can include a range of the measurable parameter from a lower bound to an upper bound of the measurable parameter. For instance, each of groups 38 can include a range of the measurable parameter corresponding to tooth width that extends from a lower bound of the tooth width for the group to an upper bound of the tooth width for the group. In some examples, the range of the measurable parameter for one of the plurality of groups can be centered about a key statistic of the measurable parameter within the plurality of surface meshes. For example, grouping module 28 can determine group 38D having a range of measurable parameters that is centered about a mode of the measurable parameters among groups 38.

A region of interest can be extracted from each surface mesh of the plurality of surface meshes (Step 68). For example, ROI extraction module 30 can extract a region of interest, such as region of interest 42, from each of surface meshes 12. Extracting the region of interest from each of the plurality of surface meshes can include aligning each surface mesh with a pre-determined coordinate system and extracting the region of interest from each surface mesh based on characteristics of the surface mesh in the pre-determined coordinate system. For instance, ROI extraction module 30 can align each of surface meshes 12 with coordinate system 40 and can extract region of interest 42 from each of surface meshes 12 (e.g., corresponding to a buccal surface of a tooth) as the region of surface meshes 12 that has a positive value of third axis 48.

A plurality of aligned surface meshes can be generated by aligning, for each group of the plurality of groups, a region of interest of each surface mesh included in the group (Step 70). For example, alignment module 32 can align an extracted region of interest of each of surface meshes 12 included in group 38D to generate a plurality of aligned surface meshes 12 for group 38D, the aggregation of vertices of which form point cloud 56. Alignment module 32 can similarly align, for each of groups 38A, 38B, 38C, 38E, 38F, 38G, and 38H, an extracted region of interest of each of surface meshes 12 included in the respective one of groups 38A, 38B, 38C, 38E, 38F, 38G, and 38F to generate a plurality of aligned surface meshes 12 for each of groups 38A, 38B, 38C, 38E, 38F, 38G, and 38H. Aligning, for each group of the plurality of groups, each surface mesh included in the group to generate the plurality of aligned surface meshes can include aligning, for each group of the plurality of groups, a coordinate system associated with each surface mesh included in the group to the coordinate system associated with a selected surface mesh included in the group. The selected surface mesh can correspond to a median of the measurable parameters among the surface meshes included in the group. For instance, alignment module 32 can align each of surface meshes 12 included in each of groups 38 to a respective one of surface meshes 12 associated with a median measurable parameter corresponding to tooth width for the respective one of groups 38.

Aligning, for each group of the plurality of groups, the coordinate system associated with each surface mesh included in the group to the coordinate system associated with the selected surface mesh included in the group can be performed using an iterative closest point algorithm. Aligning the coordinate system associated with each surface mesh included in the group to the coordinate system associated with the selected surface mesh using the iterative closest point algorithm can include first aligning, for each group of the plurality of groups, a first axis of the three-axis coordinate system associated with each surface mesh included in the group, and next aligning, for each group of the plurality of groups, second and third axes of the three-axis coordinate system associated with each surface mesh included in the group using the iterative closest point algorithm. For instance, alignment module 32 can first align, for each of groups 38, an x-axis associated with each surface mesh included in the group. Alignment module 32 can subsequently align, for each of groups 38, both a y-axis and a z-axis associated with each surface mesh included in the group using the iterative closest point algorithm.

A reconstructed mesh can be generated for each group of the plurality of groups based on the vertices and faces of each aligned surface mesh included in the group (Step 72). Generating, for each group, the reconstructed mesh based on the vertices and faces of each aligned surface mesh included in the group can be performed using a Poisson surface reconstruction algorithm. For example, mesh reconstruction module 34 can generate reconstructed mesh 58 using a Poisson surface reconstruction algorithm based on vertices and faces of each aligned surface mesh included in group 38D. Mesh reconstruction module 34 can similarly generate a reconstructed mesh using the Poisson surface reconstruction algorithm for each of groups 38 based on vertices and faces of each aligned surface mesh included in the respective group. Each face of each aligned surface mesh can be associated with a surface normal. Generating, for each group, the reconstructed mesh based on the vertices and faces of each aligned surface mesh included in the group using the Poisson surface reconstruction algorithm can be based only on the surface normal associated with each face of each aligned surface mesh and the vertices of each aligned surface mesh.

An appliance can be designed for each group based on the reconstructed surface mesh for the group (Step 74). For instance, buccal tube appliance 60 can be designed based on reconstructed surface mesh 58 for group 38D. Similarly, a buccal tube appliance (or other appliance) can be designed for each of groups 38 based on the reconstructed surface mesh for the respective group.

Accordingly, appliances, such as brackets, buccal tubes, respirators, helmets, gloves, vests, visors, handles, or other appliances can be designed based on a reconstructed mesh that is generated from a plurality of surface meshes. The received surface meshes can be segregated into population groups according to one or more measurable parameters of the respective surface mesh that correspond to one or more physical characteristics of the object that the surface mesh represents. Reconstructed meshes can be generated for each group based on the surface meshes included in the group. Appliances can be generated for each group such that an interface region of the appliance complements the reconstructed mesh for the respective group. As such, techniques of this disclosure can increase an accuracy of fit between the interface region of the appliance and objects having at least one measurable parameter corresponding to the designed appliance.

In another example, surface meshes 12 can be received (e.g., by computing device 14 via communication device(s) 18). Each of surface meshes 12 can represent an object. For instance, each of surface meshes 12 can be a three-dimensional mesh including vertices representing points on a human face and faces which encode connections between the vertices.

Each of surface meshes 12 can be pre-aligned to a common coordinate system, such as to a pre-determined coordinate system or using one of surface meshes 12 as a reference. For instance, the nose tip in the faces of each of surface meshes 12 can be oriented in the same direction and the individual surface meshes 12 transformed so that the nose-tip is an origin in the common coordinate system.

Using one of the surface meshes 12 as a reference mesh, each of surface meshes 12 can be aligned to the reference system using an iterative closet point (ICP) registration algorithm producing translational and rotational transformation to minimize the difference between the pair of meshes. For each registered mesh in the group, surface normals can be computed. For example, surface normals can be computed for each face of each of surface meshes 12 that are orthogonal to the plane formed by the vertices of face in consideration.

Using the surface normals computed for the aligned meshes, a reconstructed mesh can be generated, such as by mesh reconstruction module 34. For example, mesh reconstruction module 34 can use the vertices of the group of aligned surfaces meshes 12 and the normals for the face containing a polygon of the vertices. Mesh reconstruction module 34, in certain examples, can eliminate outlier vertices from the reconstructed mesh by rejecting (e.g., removing) vertices having an insufficient number of neighboring vertices within a threshold distance in the neighborhood of each vertex. The reconstructed mesh, in this examples, can be considered an aggregate representation of the group of aligned surface meshes 12 collected for human faces.

The reconstructed mesh can be aligned with a surface mesh that represents the shell of a respirator, e.g., such that the surface mesh of the shell of the respirator lies over the surface of the reconstructed mesh. The alignment can be carried using manual input by annotating key-point landmarks on the reconstructed mesh including, but not limited to, a nose-tip, a center of the face chin, a middle of the eyes on the face, and an edge of the two lips. In other examples, alignment can be performed using an algorithm to automatically locate key-point landmarks.

Vertices of the aligned respirator mesh can projected on to the surface of the reconstructed mesh. The projection can be computed using the surface normals for faces of the reconstructed mesh. The projection of vertices can cover a subset of the surface of the reconstructed mesh. Using the projection, contour vertices of the projection can be computed by extracting boundary points of the projection.

Surface vertices present in a neighborhood of a threshold distance (e.g., 10 mm) from the contour vertices can be extracted to yield a surface mesh of faces and vertices. The extracted surface mesh can be smoothed to discard jagged faces. The smoothing of the extracted surface mesh can be carried out by using a spline smoothing algorithm. The resulting smooth surface mesh can be used to generate an appliance, such as to print a face seal for a respirator.

Discussion of Possible Embodiments

The following are non-exclusive descriptions of possible embodiments of the present invention.

A computer-implemented method can include receiving a plurality of surface meshes, each surface mesh including vertices and faces representing an object. The method can further include assigning, with a processor, each surface mesh of the plurality of surface meshes to one of a plurality of groups, and extracting a region of interest from each surface mesh of the plurality of surface meshes. The method can further include aligning with the processor, for each group of the plurality of groups, a region of interest of each surface mesh included in the group to generate a plurality of aligned surface meshes, and generating with the processor, for each group of the plurality of groups, a reconstructed mesh based on the vertices and faces of each aligned surface mesh included in the group.

The method of the preceding paragraph can optionally include, additionally and/or alternatively, any one or more of the following features, configurations, operations, and/or additional components:

Assigning, with the processor, each surface mesh of the plurality of surface meshes to one of the plurality of groups can be performed based on one or more measurable parameters of each surface mesh.

The one or more measurable parameters can correspond to one or more physical characteristic of the object represented by the surface mesh.

The method can further include determining, with the processor, the plurality of groups based on a distribution of the one or more measurable parameters among the plurality of surface meshes.

Determining, with the processor, the plurality of groups based on the distribution of the one or more measurable parameters among the plurality of surface meshes can be performed using a clustering algorithm that identifies the plurality of groups based on differences of the one or more measurable parameters between surface meshes.

Each of the plurality of groups can include a range of the one or more measurable parameters from a lower bound to an upper bound of the one or more measurable parameters. The range of the one or more measurable parameters for one of the plurality of groups can be centered about a mode of the one or more measurable parameters within the plurality of surface meshes.

Extracting the region of interest from each of the plurality of surface meshes can include aligning, with the processor, each surface mesh with a pre-determined coordinate system, and extracting, with the processor, the region of interest from each surface mesh based on characteristics of the surface mesh in the pre-determined coordinate system.

Each surface mesh of the plurality of surface meshes can be associated with a coordinate system. Aligning, with the processor, for each group of the plurality of groups, each surface mesh included in the group to generate the plurality of aligned surface meshes can include aligning, for each group of the plurality of groups, the coordinate system associated with each surface mesh included in the group to the coordinate system associated with a selected surface mesh included in the group.

Assigning, with the processor, each of the plurality of surface meshes to one of the plurality of groups can be performed based on one or more measurable parameters of the surface mesh including width, length, difference, surface, area, or registration error.

The coordinate system associated with each surface mesh of the plurality of surface meshes can be a three-axis coordinate system. Aligning, with the processor, for each group of the plurality of groups, the coordinate system associated with each surface mesh included in the group to the coordinate system associated with the selected surface mesh included in the group can include first aligning, with the processor, for each group of the plurality of groups, a first axis of the three-axis coordinate system associated with each surface mesh included in the group, and next aligning, with the processor, for each group of the plurality of groups, second and third axes of the three-axis coordinate system associated with each surface mesh included in the group using an iterative closest point algorithm.

Generating, with the processor, for each group, the reconstructed mesh based on the vertices and faces of each aligned surface mesh included in the group can be performed using at least one of a Poisson surface reconstruction, marching cubes, grid projection, surface element smoothing, greedy projection triangulation, convex hull, and concave hull algorithm.

Each of the plurality of surface meshes can include a three-dimensional surface mesh.

The method can further include designing, with the processor, an appliance for each group based on the reconstructed surface mesh for the group.

A system can include at least one processor and computer-readable memory. The computer-readable memory can be encoded with instructions that, when executed by the at least one processor, cause the system to receive a plurality of surface meshes, each surface mesh including vertices and faces representing an object. The computer-readable memory can be further encoded with instructions that, when executed by the at least one processor, cause the system to assign each surface mesh of the plurality of surface meshes to one of a plurality of groups, and extract a region of interest from each surface mesh of the plurality of surface meshes. The computer-readable memory can be further encoded with instructions that, when executed by the at least one processor, cause the system to align, for each group of the plurality of groups, a region of interest of each surface mesh included in the group to generate a plurality of aligned surface meshes, and generate, for each group of the plurality of groups, a reconstructed mesh based on the vertices and faces of each aligned surface mesh included in the group.

The system of the preceding paragraph can optionally include, additionally and/or alternatively, any one or more of the following features, configurations, operations, and/or additional components:

The computer-readable memory can be further encoded with instructions that, when executed by the at least one processor, cause the system to assign each surface mesh of the plurality of surface meshes to one of the plurality of groups by at least causing the system to assign each surface mesh of the plurality of surface meshes to one of the plurality of groups based on one or more measurable parameters of each surface mesh.

The one or more measurable parameters can correspond to one or more physical characteristics of the object represented by the surface mesh.

The computer-readable memory can be further encoded with instructions that, when executed by the at least one processor, cause the system to determine the plurality of groups by at least causing the system to determine the plurality of groups based on a distribution of the one or more measurable parameters among the plurality of surface meshes.

The computer-readable memory can be further encoded with instructions that, when executed by the at least one processor, cause the system to determine the plurality of groups based on the distribution of the one or more measurable parameters among the plurality of surface meshes by at least causing the system to determine the plurality of groups based on the distribution of the one or more measurable parameters among the plurality of surface meshes using a clustering algorithm that identifies the plurality of groups based on differences of the one or more measurable parameters between surface meshes.

Each of the plurality of groups can include a range of the one or more measurable parameters from a lower bound to an upper bound of the one or more measurable parameters.

The range of the one or more measurable parameters for one of the plurality of groups can be centered about a mode of the one or more measurable parameters within the plurality of surface meshes.

The computer-readable memory can be further encoded with instructions that, when executed by the at least one processor, cause the system to extract the region of interest from each of the plurality of surface meshes by at least causing the system to align each surface mesh with a pre-determined coordinate system, and extract the region of interest from each surface mesh based on characteristics of the surface mesh in the pre-determined coordinate system.

Each surface mesh of the plurality of surface meshes can be associated with a coordinate system. The computer-readable memory can be further encoded with instructions that, when executed by the at least one processor, cause the system to align, for each group of the plurality of groups, each surface mesh included in the group to generate the plurality of aligned surface meshes by at least causing the system to align, for each group of the plurality of groups, the coordinate system associated with each surface mesh included in the group to the coordinate system associated with a selected surface mesh included in the group.

The computer-readable memory can be further encoded with instructions that, when executed by the at least one processor, cause the system to assign each of the plurality of surface meshes to one of the plurality of groups by at least causing the system to assign each of the plurality of surface meshes to one of the plurality of groups based on one or more measurable parameters of the surface mesh including width, length, difference, surface, area, or registration error.

The coordinate system associated with each surface mesh of the plurality of surface meshes can be a three-axis coordinate system. The computer-readable memory can be further encoded with instructions that, when executed by the at least one processor, cause the system to align, for each group of the plurality of groups, the coordinate system associated with each surface mesh included in the group to the coordinate system associated with the selected surface mesh included in the group by at least causing the system to first align, for each group of the plurality of groups, a first axis of the three-axis coordinate system associated with each surface mesh included in the group, and next align, for each group of the plurality of groups, second and third axes of the three-axis coordinate system associated with each surface mesh included in the group using an iterative closest point algorithm.

The computer-readable memory can be further encoded with instructions that, when executed by the at least one processor, cause the system to generate, for each group, the reconstructed mesh based on the vertices and faces of each aligned surface mesh included in the group by at least causing the system to generate, for each group, the reconstructed mesh based on the vertices and faces of each aligned surface mesh included in the group using at least one of a Poisson surface reconstruction, marching cubes, grid projection, surface element smoothing, greedy projection triangulation, convex hull, and concave hull algorithm.

Each of the plurality of surface meshes can include a three-dimensional surface mesh.

### Exemplary Embodiments

Embodiment 1. A computer-implemented method comprising:
receiving a plurality of surface meshes, each surface mesh comprising vertices and faces representing an object;
assigning, with a processor, each surface mesh of the plurality of surface meshes to one of a plurality of groups;
extracting, with the processor, a region of interest from each surface mesh of the plurality of surface meshes;
aligning, with the processor, for each group of the plurality of groups, a region of interest of each surface mesh included in the group to generate a plurality of aligned surface meshes; and
generating, with the processor, for each group of the plurality of groups, a reconstructed mesh based on the vertices and faces of each aligned surface mesh included in the group.

Embodiment 2. The method of Embodiment 1,
wherein assigning, with the processor, each surface mesh of the plurality of surface meshes to one of the plurality of groups is performed based on one or more measurable parameters of each surface mesh.

Embodiment 3. The method of Embodiment 2,
wherein the one or more measurable parameters correspond to one or more physical characteristic of the object represented by the surface mesh.

Embodiment 4. The method of Embodiment 2, further comprising:
determining, with the processor, the plurality of groups based on a distribution of the one or more measurable parameters among the plurality of surface meshes.

Embodiment 5. The method of Embodiment 4,
wherein determining, with the processor, the plurality of groups based on the distribution of the one or more measurable parameters among the plurality of surface meshes is performed using a clustering algorithm that identifies the plurality of groups based on differences of the one or more measurable parameters between surface meshes.

Embodiment 6. The method of Embodiment 2,
wherein each of the plurality of groups includes a range of the one or more measurable parameters from a lower bound to an upper bound of the one or more measurable parameters; and
wherein the range of the one or more measurable parameters for one of the plurality of groups is centered about a mode of the one or more measurable parameters within the plurality of surface meshes.

Embodiment 7. The method of any one of Embodiment 1-6, wherein extracting the region of interest from each of the plurality of surface meshes comprises:
aligning, with the processor, each surface mesh with a pre-determined coordinate system; and
extracting, with the processor, the region of interest from each surface mesh based on characteristics of the surface mesh in the pre-determined coordinate system.

Embodiment 8. The method of any one of Embodiment 1-7,
wherein each surface mesh of the plurality of surface meshes is associated with a coordinate system; and
wherein aligning, with the processor, for each group of the plurality of groups, each surface mesh included in the group to generate the plurality of aligned surface meshes comprises aligning, for each group of the plurality of groups, the coordinate system associated with each surface mesh included in the group to the coordinate system associated with a selected surface mesh included in the group.

Embodiment 9. The method of Embodiment 8,
wherein assigning, with the processor, each of the plurality of surface meshes to one of the plurality of groups is performed based on one or more measurable parameters of the surface mesh including width, length, difference, surface, area, or registration error.

Embodiment 10. The method of Embodiment 8,
wherein the coordinate system associated with each surface mesh of the plurality of surface meshes is a three-axis coordinate system; and
wherein aligning, with the processor, for each group of the plurality of groups, the coordinate system associated with each surface mesh included in the group to the coordinate system associated with the selected surface mesh included in the group comprises:
   first aligning, with the processor, for each group of the plurality of groups, a first axis of the three-axis coordinate system associated with each surface mesh included in the group; and
   next aligning, with the processor, for each group of the plurality of groups, second and third axes of the three-axis coordinate system associated with each surface mesh included in the group using an iterative closest point algorithm.

Embodiment 11. The method of any one of Embodiment 1-10,
wherein generating, with the processor, for each group, the reconstructed mesh based on the vertices and faces of each aligned surface mesh included in the group is performed using at least one of a Poisson surface reconstruction, marching cubes, grid projection, surface element smoothing, greedy projection triangulation, convex hull, and concave hull algorithm.

Embodiment 12. The method of any one of Embodiment 1-11,
wherein each of the plurality of surface meshes comprises a three-dimensional surface mesh.

Embodiment 13. The method of any one of Embodiment 1-12, further comprising:
designing, with the processor, an appliance for each group based on the reconstructed surface mesh for the group.

Embodiment 14. A system comprising:
at least one processor; and
computer-readable memory encoded with instructions that, when executed by the at least one processor, cause the system to:
   receive a plurality of surface meshes, each surface mesh comprising vertices and faces representing an object;
   assign each surface mesh of the plurality of surface meshes to one of a plurality of groups;
   extract a region of interest from each surface mesh of the plurality of surface meshes;
   align, for each group of the plurality of groups, a region of interest of each surface mesh included in the group to generate a plurality of aligned surface meshes; and
   generate, for each group of the plurality of groups, a reconstructed mesh based on the vertices and faces of each aligned surface mesh included in the group.

Embodiment 15. The system of Embodiment 14,
wherein the computer-readable memory is further encoded with instructions that, when executed by the at least one processor, cause the system to assign each surface mesh of the plurality of surface meshes to one of the plurality of groups by at least causing the system to assign each surface mesh of the plurality of surface meshes to one of the plurality of groups based on one or more measurable parameters of each surface mesh.

Embodiment 16. The system of Embodiment 15,
wherein the one or more measurable parameters correspond to one or more physical characteristics of the object represented by the surface mesh.

Embodiment 17. The system of Embodiment 15,
wherein the computer-readable memory is further encoded with instructions that, when executed by the at least one processor, cause the system to determine the plurality of groups by at least causing the system to determine the plurality of groups based on a distribution of the one or more measurable parameters among the plurality of surface meshes.

Embodiment 18. The system of Embodiment 17,
wherein the computer-readable memory is further encoded with instructions that, when executed by the at least one processor, cause the system to determine the plurality of groups based on the distribution of the one or more measurable parameters among the plurality of surface meshes by at least causing the system to determine the plurality of groups based on the distribution of the one or more measurable parameters among the plurality of surface meshes using a clustering algorithm that identifies the plurality of groups based on differences of the one or more measurable parameters between surface meshes.

Embodiment 19. The system of Embodiment 15,
wherein each of the plurality of groups includes a range of the one or more measurable parameters from a lower bound to an upper bound of the one or more measurable parameters; and
wherein the range of the one or more measurable parameters for one of the plurality of groups is centered about a mode of the one or more measurable parameters within the plurality of surface meshes.

Embodiment 20. The system of any one of Embodiment 14-19,
wherein the computer-readable memory is further encoded with instructions that, when executed by the at least one processor, cause the system to extract the region of interest from each of the plurality of surface meshes by at least causing the system to:
   align each surface mesh with a pre-determined coordinate system; and
   extract the region of interest from each surface mesh based on characteristics of the surface mesh in the pre-determined coordinate system.

Embodiment 21. The system of any one of Embodiment 14-20,
wherein each surface mesh of the plurality of surface meshes is associated with a coordinate system; and
wherein the computer-readable memory is further encoded with instructions that, when executed by the at least one processor, cause the system to align, for each group of the plurality of groups, each surface mesh included in the group to generate the plurality of aligned surface meshes by at least causing the system to align, for each group of the plurality of groups, the coordinate system associated with each surface mesh included in the group to the coordinate system associated with a selected surface mesh included in the group.

Embodiment 22. The system of Embodiment 21,
wherein the computer-readable memory is further encoded with instructions that, when executed by the at least one processor, cause the system to assign each of the plurality of surface meshes to one of the plurality of groups by at least causing the system to assign each of the plurality of surface meshes to one of the plurality of groups based on one or more measurable parameters of the surface mesh including width, length, difference, surface, area, or registration error.

Embodiment 23. The system of Embodiment 21,
wherein the coordinate system associated with each surface mesh of the plurality of surface meshes is a three-axis coordinate system; and
wherein the computer-readable memory is further encoded with instructions that, when executed by the at least one processor, cause the system to align, for each group of the plurality of groups, the coordinate system associated with each surface mesh included in the group to the coordinate system associated with the selected surface mesh included in the group by at least causing the system to:
   first align, for each group of the plurality of groups, a first axis of the three-axis coordinate system associated with each surface mesh included in the group; and
   next align, for each group of the plurality of groups, second and third axes of the three-axis coordinate system associated with each surface mesh included in the group using an iterative closest point algorithm.

Embodiment 24. The system of any one of Embodiment 14-23,
wherein the computer-readable memory is further encoded with instructions that, when executed by the at least one processor, cause the system to generate, for each group, the reconstructed mesh based on the vertices and faces of each aligned surface mesh included in the group by at least causing the system to generate, for each group, the reconstructed mesh based on the vertices and faces of each aligned surface mesh included in the group using at least one of a Poisson surface reconstruction, marching cubes, grid projection, surface element smoothing, greedy projection triangulation, convex hull, and concave hull algorithm.

Embodiment 25. The system of any one of Embodiment 14-24,
wherein each of the plurality of surface meshes comprises a three-dimensional surface mesh.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof Therefore, it is intended that the invention not be limited to the particular embodiment(s) disclosed, but that the invention will include all embodiments falling within the scope of the appended claims.

1. A computer-implemented method comprising:
receiving a plurality of surface meshes, each surface mesh comprising vertices and faces representing an object;
assigning, with a processor, each surface mesh of the plurality of surface meshes to one of a plurality of groups;
extracting, with the processor, a region of interest from each surface mesh of the plurality of surface meshes;
aligning, with the processor, for each group of the plurality of groups, a region of interest of each surface mesh included in the group to generate a plurality of aligned surface meshes; and
generating, with the processor, for each group of the plurality of groups, a reconstructed mesh based on the vertices and faces of each aligned surface mesh included in the group.

2. The method of claim 1,
wherein assigning, with the processor, each surface mesh of the plurality of surface meshes to one of the plurality of groups is performed based on one or more measurable parameters of each surface mesh.

3. The method of claim 2, further comprising:
determining, with the processor, the plurality of groups based on a distribution of the one or more measurable parameters among the plurality of surface meshes.

4. The method of claim 3,
wherein determining, with the processor, the plurality of groups based on the distribution of the one or more measurable parameters among the plurality of surface meshes is performed using a clustering algorithm that identifies the plurality of groups based on differences of the one or more measurable parameters between surface meshes.

5. The method of claim 1, wherein extracting the region of interest from each of the plurality of surface meshes comprises:
aligning, with the processor, each surface mesh with a pre-determined coordinate system; and
extracting, with the processor, the region of interest from each surface mesh based on characteristics of the surface mesh in the pre-determined coordinate system.

6. The method of claim 1,
wherein each surface mesh of the plurality of surface meshes is associated with a coordinate system; and
wherein aligning, with the processor, for each group of the plurality of groups, each surface mesh included in the group to generate the plurality of aligned surface meshes comprises aligning, for each group of the plurality of groups, the coordinate system associated with each surface mesh included in the group to the coordinate system associated with a selected surface mesh included in the group.

7. The method of claim 6,
wherein the coordinate system associated with each surface mesh of the plurality of surface meshes is a three-axis coordinate system; and
wherein aligning, with the processor, for each group of the plurality of groups, the coordinate system associated with each surface mesh included in the group to the coordinate system associated with the selected surface mesh included in the group comprises:
first aligning, with the processor, for each group of the plurality of groups, a first axis of the three-axis coordinate system associated with each surface mesh included in the group; and
next aligning, with the processor, for each group of the plurality of groups, second and third axes of the three-axis coordinate system associated with each surface mesh included in the group using an iterative closest point algorithm.

8. A system comprising:
at least one processor; and
computer-readable memory encoded with instructions that, when executed by the at least one processor, cause the system to:
receive a plurality of surface meshes, each surface mesh comprising vertices and faces representing an object;
assign each surface mesh of the plurality of surface meshes to one of a plurality of groups;
extract a region of interest from each surface mesh of the plurality of surface meshes;
align, for each group of the plurality of groups, a region of interest of each surface mesh included in the group to generate a plurality of aligned surface meshes; and
generate, for each group of the plurality of groups, a reconstructed mesh based on the vertices and faces of each aligned surface mesh included in the group.

9. The system of claim 8,
wherein the computer-readable memory is further encoded with instructions that, when executed by the at least one processor, cause the system to assign each surface mesh of the plurality of surface meshes to one of the plurality of groups by at least causing the system to assign each surface mesh of the plurality of surface meshes to one of the plurality of groups based on one or more measurable parameters of each surface mesh.

10. The system of claim 9,
wherein the one or more measurable parameters correspond to one or more physical characteristics of the object represented by the surface mesh.

11. The system of claim 8,
wherein each surface mesh of the plurality of surface meshes is associated with a coordinate system; and
wherein the computer-readable memory is further encoded with instructions that, when executed by the at least one processor, cause the system to align, for each group of the plurality of groups, each surface mesh included in the group to generate the plurality of aligned surface meshes by at least causing the system to align, for each group of the plurality of groups, the coordinate system associated with each surface mesh included in the group to the coordinate system associated with a selected surface mesh included in the group.

12. The system of claim 11,
wherein the computer-readable memory is further encoded with instructions that, when executed by the at least one processor, cause the system to assign each of the plurality of surface meshes to one of the plurality of groups by at least causing the system to assign each of the plurality of surface meshes to one of the plurality of groups based on one or more measurable parameters of the surface mesh including width, length, difference, surface, area, or registration error.

13. The system of claim 11,
wherein the coordinate system associated with each surface mesh of the plurality of surface meshes is a three-axis coordinate system; and
wherein the computer-readable memory is further encoded with instructions that, when executed by the at least one processor, cause the system to align, for each group of the plurality of groups, the coordinate system associated with each surface mesh included in the group to the coordinate system associated with the selected surface mesh included in the group by at least causing the system to:
first align, for each group of the plurality of groups, a first axis of the three-axis coordinate system associated with each surface mesh included in the group; and
next align, for each group of the plurality of groups, second and third axes of the three-axis coordinate system associated with each surface mesh included in the group using an iterative closest point algorithm.

14. The system of claim 8,
wherein the computer-readable memory is further encoded with instructions that, when executed by the at least one processor, cause the system to generate, for each group, the reconstructed mesh based on the vertices and faces of each aligned surface mesh included in the group by at least causing the system to generate, for each group, the reconstructed mesh based on the vertices and faces of each aligned surface mesh included in the group using at least one of a Poisson surface reconstruction, marching cubes, grid projection, surface element smoothing, greedy projection triangulation, convex hull, and concave hull algorithm.

15. The system of claim 8,
wherein each of the plurality of surface meshes comprises a three-dimensional surface mesh.
